(19) United States
(12) Patent Application Publication
(10) Pub. No.: US 2011/0189543 A1
(43) Pub. Date: Aug. 4, 2011

(54) Cathode active material with magnesium, and magnesium secondary battery with the same

(75) Inventors: Dong Hyeok Choi, Suwon-si (KR); Hak Kwan Kim, Hasnm-si (KR); Hyun Chul Jung, Suwon-si (KR)

(73) Assignee: SAMSUNG ELECTRO-MECHANICS CO., LTD., SUWON (KR)

(21) Appl. No.: 12/662,260

(22) Filed: Apr. 7, 2010

(30) Foreign Application Priority Data
Feb. 4, 2010 (KR) 10-2010-0010337

(51) Int. Cl. H01M 4/02; C01F 5/00; H01M 4/46

(52) U.S. Cl. 429/220; 252/182.1; 423/594.16; 429/221; 429/223; 429/224; 429/229; 429/231.5; 429/231.6

(57) ABSTRACT

Disclosed herein is a magnesium secondary battery. The magnesium secondary battery includes an anode, a cathode, and an electrolyte material in which carrier ions, used as carriers between the anode and the cathode at the time of charge/discharge, are received, wherein at least any one of the cathode and the cathode is composed of a spinel crystal structure having magnesium ions Mg.

### CROSS REFERENCE TO RELATED APPLICATION

This application claims the benefit of Korean Patent Application No. 10-2010-0010337, filed on Feb. 4, 2010, entitled “Cathode Active Material With Magnesium, And Magnesium Secondary Battery With The Same”, which is hereby incorporated by reference in its entirety into this application.

### BACKGROUND OF THE INVENTION

1. Technical Field

The present invention relates to a cathode active material and a secondary battery with the same, and more particularly, to a cathode active material with magnesium in order to improve charge/discharge efficiency and charge capacity, and a magnesium secondary battery using the magnesium as a charge/discharge mediator.

2. Description of the Related Art

Recently, studies on secondary batteries that can be reused as power supplies for mobile electron apparatuses such as a cellular phone, a notebook computer, a personal digital assistant (PDA), a MP3, etc., electric vehicles, etc., by being charged or discharged, have been actively made. Currently, the secondary batteries have become smaller and lighter due to the recent rapid development of electronic device technology and various attempts for improving charge/discharge efficiency thereof have also been made.

The cathode active material for lithium secondary batteries that are currently and mainly used are composed of a layered structure compound. For example, as for general cathode active materials, they may use oxide-based compounds such as LiCoO₂, LiNiO₂, LiMn₂O₄, LiFePO₄, etc. LiCoO₂, the representative cathode active material of the cathode active materials described above, has the following compound structure.

FIG. 1 is a diagram showing a crystal structure of a LiCoO₂ compound that is used as a cathode active material of a lithium secondary battery according to the related art, and FIG. 2 is a diagram showing a unit crystal structure of a LiCoO₂ compound shown in FIG. 1.

Referring to FIGS. 1 and 2, the general structure of the LiCoO₂ compound 10 may have a hexagonal unit crystal 20. In the unit crystal 20, Li atoms Li, oxygen atoms O, and cobalt atoms Co that are transition metal atoms generally form a layered structure, respectively. Therefore, the unit crystal 20 is configured of an oxygen atom layer 22, a transition metal atom layer 24, and a lithium atom layer 26 that is disposed between the oxygen atom layer 22 and the transition metal atom layer 24.

However, owing to the layered structure described above, the lithium secondary battery with the cathode active materials described above has low charge/discharge efficiency and low charge capacity. More specifically, in the crystal structure 20 having the layered structure described above, the lithium atoms Li move between the oxygen atom layer 22 and the transition metal atom layer 24 at the time of charging/discharging the lithium secondary battery. At this time, the movement of the lithium atoms Li is generally limited to a horizontal direction X to the oxygen and transition metal atom layers 22 and 24. In other words, the movement of the lithium atoms Li for the charge/discharge thereof is limited by the oxygen and transition metal atom layers 22 and 24, such that the crystal structure 20 has a structure where the movement of the lithium atoms Li, which are reaction mediators, is not free at the time of charging/discharging the secondary battery.

When most of the lithium atoms Li are escaped from the space between the oxygen atom layer 22 and the transition metal atom layer 24 at the time of charge/discharge, the oxygen atom layer 22 and the transition metal atom layer 24 may be adjacent to each other. In this case, owing to the repulsive force between the adjacent oxygen layers, the crystal structure 20 is very likely to be broken. Alternatively, even when most of the lithium atoms Li are not escaped from the space between the oxygen atom layer 22 and the transition metal atom layer 24, the amount of lithium ions in the crystal structure 20 is reduced, such that the crystal structure 20 is gradually modified into a monoclinic crystal structure from a hexagonal crystal structure. The modification of the crystal structure 20 described above reduces the charge capacity of the secondary battery and limits a use rate of the lithium ions at the time of charge/discharge to below 50% compared to a theoretical use rate thereof.

For example, when the secondary battery is constituted by including an anode made of O₆ (graphite) and a cathode made of the LiCoO₂, the charge/discharge reaction equation of the secondary battery is determined by 0.5LiC₆+LiCoO₂=0.5C₆+LiCoO₂. As can be appreciated from the reaction equation, it is confirmed that only 50% of the lithium ions included in the LiCoO₂ is used in charging and discharging. This is the reason that the crystal structure of the LiCoO₂ has a layered structure so that the mobility of the lithium ions Li is limited.

### SUMMARY OF THE INVENTION

The present invention has been made in an effort to provide a cathode active material that improves charge capacity and charge/discharge efficiency of a secondary battery.

The present invention has been also made in an effort to provide a magnesium secondary battery that improves charge capacity and charge/discharge efficiency.

An exemplary embodiment of the present invention provides a cathode active material including: a magnesium metal oxide having a spinel crystal structure composed of magnesium ions, metal ions, and oxygen ions.

The magnesium ions may be positioned in the center of a regular tetrahedron composed of the plurality of oxygen ions.

The metal ions may be positioned in the center of an octahedron composed of the plurality of oxygen ions.

The cathode active material may meet the following formula.

Mg₍₁₊ₓ₎M₍₂₋ₓ₎O₄, 0≦X≦0.33, M=metal ion, O=oxygen ion [Formula]

The metal ion may include any one of titanium (Ti), vanadium (V), chrome (Cr), manganese (Mn), iron (Fe), cobalt (Co), nickel (Ni), copper (Cu), rubidium (Rd), germanium (Ge), molybdenum (Mo), silicon (Si), aluminum (Al), zinc (Zr), and boron (B).

Another embodiment of the present invention provides a magnesium secondary battery including: an anode; a cathode that is disposed to be opposed to the anode and has a magnesium metal oxide having a spinel crystal structure composed of magnesium ions, metal ions, and oxygen ions; and an electrolyte material that receives the magnesium ions, reaction mediators between the anode and the cathode.

The spinel crystal structure may include a regular tetrahedron structure composed of four oxygen ions; an octahedron structure composed of six oxygen ions; and the magnesium ions that are disposed in the inner center of the regular tetrahedron structure and the octahedron structure.

The magnesium secondary battery may meet the following charge/discharge reaction equation.

Mg+Fe₂O₄ [symbol] MgFe₂O₄ [Reaction equation]

(Herein, the forward reaction of the reaction equation is a discharge reaction and the inverse reaction thereof is a charge reaction.)

The cathode active material may meet the following formula.

Mg₍₁₊ₓ₎M₍₂₋ₓ₎O₄, 0≦X≦0.33, M=metal ion, O=oxygen ion [Formula]

The metal ion may include any one of titanium (Ti), vanadium (V), chrome (Cr), manganese (Mn), iron (Fe), cobalt (Co), nickel (Ni), copper (Cu), rubidium (Rd), germanium (Ge), molybdenum (Mo), silicon (Si), aluminum (Al), zinc (Zr), and boron (B).

A carbon layer may be formed on the surface of the cathode.

The anode may include an anode active material of a metal oxide composed of the magnesium ions and the metal ions.

The anode active material may include the metal oxide composed of the magnesium ions and the metal ions.

The anode active material may include the spinel crystal structure.

Yet another embodiment of the present invention provides a magnesium secondary battery including: an anode, a cathode, and an electrolyte material in which carrier ions, which are used as carriers between the anode and the cathode at the time of charge/discharge, are received, wherein at least any one crystal structure of the anode and the cathode has a spinel crystal structure having magnesium ions Mg.

The spinel crystal structure is composed of the magnesium ions, the metal ions, and the oxygen ions, wherein the magnesium ions may be positioned in the center of the regular tetrahedron structure composed of the oxygen ions and the metal ions may be positioned in the center of the octahedron structure composed of the oxygen ions.

The carrier ions may include the magnesium ions.

The magnesium secondary battery may meet the following charge/discharge reaction equation.

Mg+Fe₂O₄ [symbol] MgFe₂O₄ [Reaction equation]

(Herein, the forward reaction of the reaction equation is a discharge reaction and the inverse reaction thereof is a charge reaction.)

### BRIEF DESCRIPTION OF THE DRAWINGS

FIG. 1 is a diagram showing a crystal structure of a LiCoO₂ compound that is used as a cathode active material of a lithium secondary battery according to the related art;

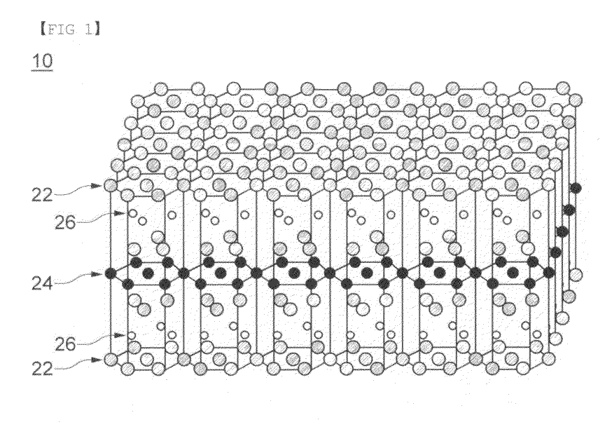

FIG. 2 is a diagram showing a unit crystal structure of a LiCoO₂ compound shown in FIG. 1;

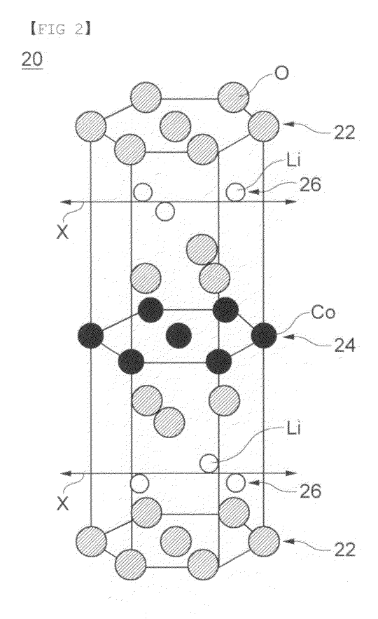

FIG. 3 is a diagram showing a magnesium secondary battery according to an exemplary embodiment of the present invention; and

FIG. 4 is a diagram showing a unit crystal structure of cathode and anode active materials shown in FIG. 3.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals denote like elements throughout the specification.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a cathode active material and a magnesium secondary battery with the same according to exemplary embodiments of the present invention will be described in detail with reference to the accompanying drawings.

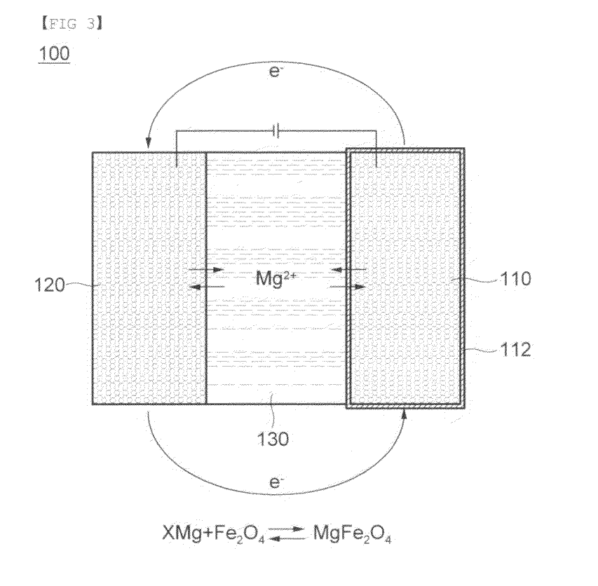

FIG. 3 is a diagram showing a magnesium secondary battery according to an exemplary embodiment of the present invention.

Referring to FIG. 3, the magnesium secondary battery 100 according to an exemplary embodiment of the present invention may be configured to include a cathode 110, an anode 120, and an electrolyte material 130. The cathode 110, the anode 120, and the electrolyte material 130 are disposed inside a predetermined housing (not shown), such that they can be protected from an external environment. The cathode 110 and the anode 120 are disposed to be spaced from each other, having the electrolyte material 130 therebetween, wherein a separator (not shown) may be disposed between the cathode 110 and the anode 120. Further, a carbon coating layer 112 that contains carbon C may be formed on the surface of the cathode 110. The carbon coating layer 112 increases the conductivity of the cathode 110, thereby making it possible to improve charge/discharge characteristics of the cathode 110.

The cathode 110 and the anode 120 can exchange carriers, which are electrochemical reaction mediators, through the electrolyte material 130. As the carrier, a magnesium ion Mg²⁺ may be used. The magnesium ion Me may be a carrier ion having a divalent ion. Therefore, the magnesium ion Me may be expected to have about twice capacity and output improvement compared to the carrier ion (for example, lithium ion Li⁺¹) having a monovalent ion. In order to use the magnesium ion Mg²⁺ as the carrier, the electrolyte material 130 may be provided as electrolyte that contains the magnesium ion Mg²⁺ in an ion state. The electrolyte material 130 may further include ammonium chloride or sodium hydroxide, etc. The magnesium ion Mg²⁺ described above may be used as the charge/discharge reaction mediator between the cathode 110 and the anode 120.

Meanwhile, any one of the cathode 110 and the anode 120 may be made of an active material having magnesium Mg. For example, the cathode 110 may be made of a cathode active material having a magnesium metal oxide composed of magnesium ions Mg, metal ions M, and oxygen ions O. For example, the cathode active material may be constituted to meet the following formula.

Mg₍₁₊ₓ₎M₍₂₋ₓ₎O₄, 0≦X≦0.33, M=metal ion, O=oxygen ion

Herein, the content of the magnesium ion Mg may be relatively more or less by approximately 30% compared to that of the metal ion M. Substantially, as the content of the magnesium ion Mg is increased, the charge/discharge efficiency of the cathode 110 can be improved. However, there may be a technical limitation in increasing the content of the magnesium ion Mg by approximately 30% or more compared to that of the metal ion M. If the technical limitation is solved, the content of the magnesium ion Mg can be controlled to be 30% or more. Further, according to the formula, as the content of the magnesium ion Mg is increased, the content of the metal ion M is relatively reduced. However, the content of the magnesium ion Mg can be selectively controlled, irrespective of the content of the metal ion M.

The metal ion M may be any one of various sorts of metal ions. For example, as for the metal ion M, it may be any one of titanium (Ti), vanadium (V), chrome (Cr), manganese (Mn), iron (Fe), cobalt (Co), nickel (Ni), copper (Cu), rubidium (Rd), germanium (Ge), molybdenum (Mo), silicon (Si), aluminum (Al), zinc (Zr), and boron (B). More preferably, the metal ion M may be any one of iron (Fe), manganese (Mn), and nickel (Ni). In this case, the cathode active materials may be any one of MgFe₂O₄, MgMn₂O₄, and MgNi₂O₄.

The anode 120 may also be made of an anode active material having magnesium Mg. For example, the cathode active material may be a metal compound composed of magnesium ions Mg and metal ions M. Alternatively, the anode 120 may be made of other material that can store a charge/discharge reaction mediator element by way of example. For example, the anode 120 may be made of a material including graphite.

The magnesium secondary battery 100 having the structure described above may meet the following charge/discharge reaction equation.

Mg+Fe₂O₄ [symbol] MgFe₂O₄

Herein, the forward reaction of the reaction equation may be a discharge reaction and the inverse reaction thereof may be a charge reaction. As shown in the reaction equation, the magnesium ion Mg performs 1:1 reaction with the metal oxide Fe₂O₄, such that the entire magnesium ions Mg that constitute the cathode active material can participate in the reaction. Therefore, the magnesium secondary battery 100 having the structure described above raises the reaction participation rate of the magnesium ions Mg²⁺, which are the charge/discharge reaction mediators, thereby making it possible to have a structure where the mobility, use rate and reaction rate of the magnesium ions Mg²⁺ are increased.

Continuously, the crystal structures of the cathode and anode active materials of the magnesium secondary battery 100 according to an exemplary embodiment of the present invention described above will be described in detail. Herein, the repetitive description of the magnesium secondary battery 100 described above will be omitted or simplified.

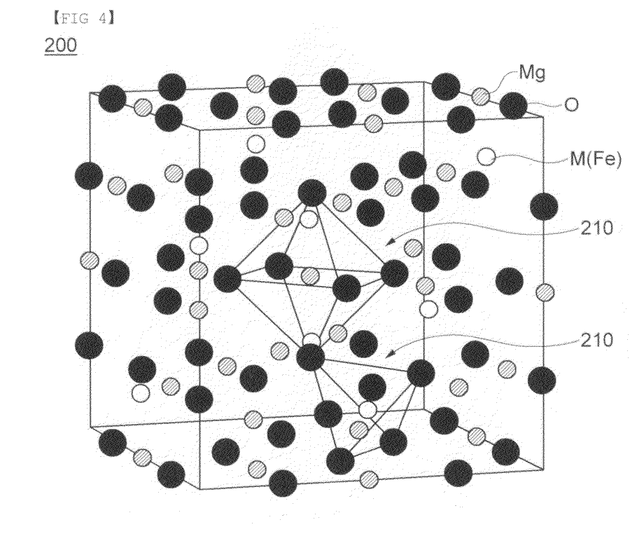

FIG. 4 is a diagram showing a unit crystal structure of a cathode active material shown in FIG. 3. Referring to FIG. 4, the cathode active material according to an exemplary embodiment of the present invention may have a spinel crystal structure 200. The spinel crystal structure may be one of the typical crystal structures of doubleoxide and doublesulfide of metal elements marked by Formula AB₂X₄. The spinel crystal structure may have a structure where a unit cell of a cubic system (for example, isometric system) that is a space group 3 includes 32 oxygen atoms forming a face-centered cubic lattice and 8 places of four coordinated positions of regular tetrahedron are filled with magnesium atoms, and 16 places of sixth coordinated positions of octahedron are filled with aluminum atoms.

For example, when the cathode active material is composed of MgFe₂O₄, the unit crystal structure of the cathode active material has the spinel crystal structure 200 described above, wherein the spinel crystal structure 200 may include a regular tetrahedron structure 210 and an octahedron structure 220. The regular tetrahedron structure 210 may be a structure configured of four oxygen ions O, and the octahedron structure 220 may be a structure configured of six oxygen ions O. Herein, the magnesium ions Mg may be positioned in the center of the regular tetrahedron structure 210, and the iron ions Fe that are the metal ions M may be positioned in the center of the octahedron structure 220. In other words, the regular tetrahedron structure 210 may have a structure where the magnesium ions Mg are positioned in the center of the regular tetrahedron configured of the oxygen ions O, and the octahedron structure 220 may have a structure where the metal ions M are positioned in the center of the octahedron configured of the six oxygen ions O. The spinel crystal structure 200 described above may also be provided, in the same manner, to a case where the cathode active material is a metal compound of MgMn₂O₄ and MgNi₂O₄.

With the spinel crystal structure 200 described above, the moving direction of the magnesium ions Mg is not limited to a predetermined direction but the magnesium ions Mg can move in various directions within the spinel crystal structure 200 at the time of charging/discharging the magnesium secondary battery 100. In other words, the magnesium ions Mg can move in various directions and go into the center of the regular tetrahedron 210 and the octahedron 220 at the time of charge. Further, the magnesium ions Mg can move in various directions and go out from the center of the regular tetrahedron 210 and the octahedron 220 at the time of discharge. This may be the reason that the spinel crystal structure 200 does not have a layered structure that may cause a limitation in the movement of the magnesium ions Mg.

As described above, the cathode 110 and the anode 120 of the magnesium secondary battery 100 according to exemplary embodiments of the present invention include the cathode active material and the anode active material, wherein the crystal structure of at least the cathode active material of the cathode and anode active materials may be configured of the spinel crystal structure 200 having magnesium. Herein, the oxygen ions O, the metal ions M, and the magnesium ions Mg, which compose the spinel crystal structure 200, may be constituted to have a structure where the magnesium ions Mg can move freely. In other words, the spinel crystal structure 200 does not have a structure (for example, a layered structure) where the moving direction of the magnesium ions Mg is limited, thereby making it possible to have a structure where the mobility of the magnesium ions Mg is high. Therefore, the magnesium secondary battery 100 can improve the charge/discharge efficiency and the charge capacity due to the magnesium ions Mg that can move freely. Further, the magnesium secondary battery 100 can more improve the charge/discharge efficiency and the charge capacity by constituting the anode active material of the anode 120 to have the spinel crystal structure 200 having magnesium.

Further, with the magnesium secondary batter 100 according to exemplary embodiments of the present invention, the crystal structure 200 of at least the cathode active material can be configured of the spinel crystal structure having magnesium. In this case, the entire crystal structure is not broken even when the carriers, which are charge/discharge reaction mediators, that is, the magnesium ions Mg, move, the magnesium secondary battery 100 can have a relatively high stability compared to the layered structure where the entire crystal structure is broken due to the movement of the carriers. Therefore, the magnesium secondary battery 100 has a structure where life span is long and thermal characteristics are excellent compared to a secondary battery with the cathode active material having a layered crystal structure.

The cathode active material according to the present invention can have the spinel crystal structure composed of the magnesium ions, the oxygen ions, and the metal ions. The spinel crystal structure described above can have a structure where the moving direction of the magnesium ions is not limited compared to the layered crystal structure where the moving direction of the carriers is limited to a horizontal direction at the time of charging/discharging the secondary battery. Therefore, the cathode active material increases the mobility and use rate of the magnesium ions, thereby making it possible to improve the charge/discharge efficiency and the charge capacity of the secondary battery.

The cathode active material according to the present invention is provided to have the spinel crystal structure composed of the magnesium ions, the oxygen ions, and the metal ions, such that the entire crystal structure thereof is not broken even when the magnesium ions, the charge/discharge reaction mediators, move. Therefore, the cathode active material can have relatively high stability, long life span, and excellent thermal characteristics compared to the secondary battery with cathode active material having the layered structure where the crystal structure thereof is broken when the carriers move.

With the magnesium secondary battery according to the present invention, the crystal structure of at least the cathode active material of the cathode and anode active materials is provided as the spinel crystal structure having magnesium, thereby making it possible to improve the mobility of the magnesium ions, the charge/discharge reaction mediators. Therefore, the magnesium secondary battery has a structure where the mobility and the use rate of the magnesium ions are improved compared to the secondary battery with the cathode active material having the layered crystal structure where the moving direction of the magnesium ions is limited to a horizontal direction, thereby making it possible to improve the charge/discharge efficiency and the charge capacity of the secondary battery. Further, the magnesium secondary battery can more improve the charge/discharge efficiency and the charge capacity of the secondary battery by constituting the anode active material to have the spinel crystal structure with magnesium described above.

With the magnesium secondary battery according to the present invention, the crystal structure of at least the cathode active material of the cathode and anode active materials is provided as the spinel crystal structure having magnesium, such that the entire crystal structure is not broken even when the magnesium ions, the charge/discharge reaction mediators, move. Therefore, the magnesium secondary battery can have relatively high stability, long life span, and excellent thermal characteristics compared to the secondary battery with the cathode active material having the layered structure where the crystal structure thereof is broken when the carriers move.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments, but, on the contrary, is intended to cover various modifications and equivalent arrangements included within the spirit and scope of the appended claims.

What is claimed is:

1. A cathode active material, comprising:
a magnesium metal oxide having a spinel crystal structure composed of magnesium ions, metal ions, and oxygen ions.

2. The cathode active material according to claim 1, wherein the magnesium ions are positioned in the center of a regular tetrahedron composed of the plurality of oxygen ions.

3. The cathode active material according to claim 1, wherein the metal ions are positioned in the center of an octahedron composed of the plurality of oxygen ions.

4. The cathode active material according to claim 1, wherein the cathode active material meets the following formula.
Mg₍₁₊ₓ₎M₍₂₋ₓ₎O₄, 0≦X≦0.33, M=metal ion, O=oxygen ion [Formula]

5. The cathode active material according to claim 4, wherein the metal ion includes any one of titanium (Ti), vanadium (V), chrome (Cr), manganese (Mn), iron (Fe), cobalt (Co), nickel (Ni), copper (Cu), rubidium (Rd), germanium (Ge), molybdenum (Mo), silicon (Si), aluminum (Al), zinc (Zr), and boron (B).

6. A magnesium secondary battery, comprising:
an anode;
a cathode that is disposed to be opposed to the anode and has a magnesium metal oxide having a spinel crystal structure composed of magnesium ions, metal ions, and oxygen ions; and
an electrolyte material that receives the magnesium ions, reaction mediators between the anode and the cathode.

7. The magnesium secondary battery according to claim 6, wherein the spinel crystal structure includes:
a regular tetrahedron structure composed of four oxygen ions;
an octahedron structure composed of six oxygen ions; and
the magnesium ions that are disposed in the inner center of the regular tetrahedron structure and the octahedron structure.

8. The magnesium secondary battery according to claim 6, wherein the magnesium secondary battery meets the following charge/discharge reaction equation.
Mg+Fe₂O₄ [symbol] MgFe₂O₄ [Reaction equation]
(Herein, the forward reaction of the reaction equation is a discharge reaction and the inverse reaction thereof is a charge reaction.)

9. The magnesium secondary battery according to claim 6, wherein the cathode active material meets the following formula.
Mg₍₁₊ₓ₎M₍₂₋ₓ₎O₄, 0≦X≦0.33, M=metal ion, O=oxygen ion [Formula]

10. The magnesium secondary battery according to claim 9, wherein the metal ion includes any one of titanium (Ti), vanadium (V), chrome (Cr), manganese (Mn), iron (Fe), cobalt (Co), nickel (Ni), copper (Cu), rubidium (Rd), germanium (Ge), molybdenum (Mo), silicon (Si), aluminum (Al), zinc (Zr), and boron (B).

11. The magnesium secondary battery according to claim 6, wherein a carbon layer is formed on the surface of the cathode.

12. The magnesium secondary battery according to claim 6, wherein the anode includes an anode active material of a metal oxide composed of the magnesium ions and the metal ions.

13. The magnesium secondary battery according to claim 12, wherein the anode active material includes the metal oxide composed of the magnesium ions and the metal ions.

14. The magnesium secondary battery according to claim 13, wherein the anode active material includes the spinel crystal structure.

15. A magnesium secondary battery, comprising:
an anode;
a cathode; and
an electrolyte material in which carrier ions, which are used as carriers between the anode and the cathode at the time of charge/discharge, are received,
wherein at least any one crystal structure of the cathode and the cathode has a spinel crystal structure having magnesium ions Mg.

16. The magnesium secondary battery according to claim 15, wherein the spinel crystal structure is composed of the magnesium ions, the metal ions, and the oxygen ions, the magnesium ions being positioned in the center of the regular tetrahedron structure composed of the oxygen ions and the metal ions being positioned in the center of the octahedron structure composed of the oxygen ions.

17. The magnesium secondary battery according to claim 15, wherein the carrier ions include the magnesium ions.

18. The magnesium secondary battery according to claim 15, wherein the magnesium secondary battery meets the following charge/discharge reaction equation.
Mg+Fe₂O₄ [symbol] MgFe₂O₄ [Reaction equation]
(Herein, the forward reaction of the reaction equation is a discharge reaction and the inverse reaction thereof is a charge reaction.)
